(19) United States
(12) Patent Application Publication
(10) Pub. No.: US 2005/0120930 A1
(43) Pub. Date: Jun. 9, 2005

(54) Vegetation embankment block combined ad

(76) Inventor: Nam Kang, Jeonrabuk-Do (KR)

Correspondence Address: Richard J Streit;Ladas & Parry, 224 South Michigan Avenue, Suite 1200, Chicago, IL, 60604, US

(21) Appl. No.: 10/477,006

(22) PCT Filed: Mar. 11, 2003
(86) PCT No.: PCT/KR03/00465

(51) Int. Cl. A01C 11/00

(52) U.S. Cl. 111/100

(57) ABSTRACT

The present invention is related to embankment block, which preventing deviation. More particularly, the present invention provides advertisement effect combined use with revetment block by planting various kinds of vegetation in order to represent literary expression, symbolic words, and advertisement copy. The characteristics of the present invention include mutual connecting method, that is, the side joining of inserting projection and groove, galvanized steel wire connecting through the wire hole that is perforated to main body and the side surface of block. The main body of block is shot through from above to below.

### BACKGROUND OF THE INVENTION

1. Field of the Invention

This application relates generally to an embankment block and more particularly to an embankment block that enables vegetation to grow through the block while providing a stronger connection between a series of assembled adjacent blocks so that a number of these blocks assembled into an embankment not only provides strong support to the sloped ground structure but also disseminates advertisement or other messages to a viewer.

2. Description of the Prior Art

Generally, conventional embankment blocks are made of a cement material in a solid block shape. They are used in various embankment structures on sloped ground surfaces on the sides of, for example, a water reservoir or dam, a tide embankment, a spillway, a running water such as a river or creek, a sloped mountain or a hill, a drainage or a drain trench, etc. Generally, the conventional embankment blocks are manufactured in a solid rectangular form with a cement material and are designed such that two adjacent blocks in a series of blocks can fit into each other.

However, there are numerous problems associated with the conventional embankment blocks. First problem, among many, is that because the conventional embankment blocks are made in the form of a solid rectangular block, they do not allow the soil underneath the blocks to come in contact with the air above the blocks. This contributes and eventually leads to the soil damage and soil contamination underneath the conventional embankment blocks, and the sustained damage and contamination cannot be repaired unless the entire embankment blocks are taken out to expose the covered-up soil.

Further, the conventional embankment blocks lack the structure that provides positive reinforcement and strong connection in the fitting between two or more contiguous conventional blocks. For this reason, the conventional blocks installed on the embankments along, for example, a river typically are not capable of withstanding the additional and fluctuating water pressure that are brought on by seasonal floods.

Accordingly, there is a need for providing an embankment block that provides a strong connection between any two or more of the assembled blocks in an embankment while allowing the covered-up soil to breathe with the air so as to prevent the soil contamination underneath the blocks. Additionally, there is a need for providing an embankment that allows growth of various natural vegetation and plants through a selected number of embankment blocks to carry a message of advertisement and the like to a viewer.

### SUMMARY OF THE INVENTION

Against this backdrop, embodiments of the present invention have been developed. An embankment block has a main body defined by a top surface, a bottom surface, and at least a first side and a second side. The embankment block includes a vegetation opening formed between the top and bottom surfaces of the main body such that the vegetation opening allows a vegetation to grow through the vegetation opening. The embankment block also includes a protruding part formed on the first side of the main body and a receiving part formed on the second side of the main body. The shape of the protruding part is substantially complimentary to the shape of the receiving part. Further, the embankment block includes a wire path formed inside the main body. The wire path has two wire path openings and each of the wire path openings is formed on a selected side of the main body.

A cap block may fit inside the vegetation opening of the main body. The cap block is shaped to substantially compliment the shape of the vegetation opening of the main body. The edges of the cap block and the edges of the vegetation opening may be tapered at an angle. The height of the cap block and the height of the main body may be different. The height of the cap block may be about 30 mm and the height of the main body may be about 100 mm.

A vegetation block may also fit inside the vegetation opening of the main body. The vegetation block is shaped to substantially compliment the shape of the vegetation opening of the main body. The vegetation block has one or more vegetation holes through which a plant can grow when the main body is laid over soil. The plant growing though the vegetation hole substantially closes the vegetation holes and thereby prevents water from directly flowing into the soil through the vegetation opening and such that the plant provides a visual effect to a viewer.

The edges of the vegetation block and the edges of the vegetation opening may be tapered at an angle. The height of the vegetation block and the height of the main body may be different such that the height of the vegetation block may be about 30 mm and the height of the main body may about 100 mm.

One opening of the wire path may be located on the protruding part of the main body and the other opening of the wire path may be located on the receiving part of the main body. The wire path accommodates a wire to run through from one opening of the wire path to the other opening of the wire path.

A plurality of the embankment blocks of the above can be fitted together to form an advertising embankment having a substantially two-dimensional surface. Each of the embankment blocks are contiguously fitted together by one protruding part of one embankment block fitted into the receiving part of an adjacent embankment block. Plants are grown through a predetermined number of the vegetation openings of the embankment blocks such that the grown plants when viewed from outside form a pattern of intended messages.

The wire path opening of the protruding part of one embankment block coincides with the wire path opening of the receiving part of another embankment block such that, when the two embankment blocks are fitted together, a continuous wire path is created internally through the two embankment blocks. A wire may run through the continuous wire path to provide a strong connection between the two or more embankment blocks fitted together.

A vegetation block may fit inside the vegetation opening of the main body. The vegetation block is shaped to substantially compliment the shape of the vegetation opening of the main body. The vegetation block has one or more vegetation holes through which a plant can grow when the main body is laid over soil, such that the plant substantially closes the vegetation holes and thereby prevents water from directly flowing into the soil through the vegetation opening and such that the plant provides a visual effect to a viewer.

These and various other features as well as advantages which characterize the present invention will be apparent from a reading of the following detailed description and a review of the associated drawings.

### BRIEF DESCRIPTION OF THE DRAWINGS

FIG. 1 is a perspective view showing an embankment block according to a first embodiment of the present invention.

FIG. 2 is a perspective view showing an embankment block according to a second embodiment of the present invention.

FIG. 3 is a perspective view showing an embankment block according to a third embodiment of the present invention.

FIG. 4 is a perspective view showing an embankment block according to a fourth embodiment of the present invention.

FIG. 5 is a perspective view showing a round vegetation block that can be utilized in the various embodiments of the present invention.

FIG. 6 is a perspective view showing a rectangular vegetation block that can be utilized in the various embodiments of the present invention.

FIG. 7 is a cross-sectional view showing vegetation (i.e., a flower) growing through an embankment block of any of the embodiments of the present invention and showing the internal structure thereof having a vegetation block and a wire running through an internal wire connecting path.

FIG. 8 is cross-sectional view showing vegetation (i.e., grass) growing through an embankment block of any of the embodiments of the present invention and showing the internal structure thereof having a cap block closing one of the vegetation openings and a vegetation block fitted in the other vegetation opening allowing the grass to grow through.

FIG. 9 is a top view of an embankment showing the interconnection of the embankment blocks, one of which is shown in FIG. 1.

FIG. 10 is a top view of an embankment showing the interconnection of the embankment blocks, one of which is shown in FIG. 2.

FIG. 11 is a top view of an embankment showing a pattern of vegetation growth in a selected number of the assembled embankment blocks such that a pattern of message is disseminated to a viewer.

### DETAILED DESCRIPTION

Embankment blocks according to various embodiments of the present invention, which are shown in the associated drawings and described herein, are utilized to provide an embankment that is, inter alia, visually pleasing to a viewer and that projects advertising messages and the like to a viewer by having a structure (i.e., one or more vegetation openings, among others) in each selected embankment block that allows various types of vegetation (e.g., shrubs, flowers, grass, tree, weeds, reeds, etc.) having variety of colors, shapes and forms, etc. to grow through. These vegetation forms a pattern on the outer surface of the embankment formed by an array of assembled embankment blocks to carry a message or image to a viewer.

In addition, the embankment blocks according to the various embodiments of the present invention described herein enable the roots and/or the stem of the vegetation grown through the vegetation openings to effectively close the vegetation opening so as to prevent excessive water, for example, from a heavy rainfall from being drained into the soil underneath the blocks through the vegetation openings. This prevents collapse or weakening of the soil situated underneath the embankment blocks, while facilitating the bulk of the flowing water to flow on the top surface along the downward slope of the embankment.

Further, the vegetation openings in the embankment blocks according the various embodiments of the present invention allow the soil covered up beneath the embankment blocks to come in contact with (or “breathe”) the outside air. This prevents the soil from being damaged or contaminated due to the isolation from the ambient atmosphere or the sunlight.

Further yet, the embankment blocks according to various embodiments of the present invention provides an internal structure of a wire path that runs internally and continuously through all of the assembled adjacent embankment blocks. A wire or a string of other kinds can be run through the wire path such that the assembled embankment blocks are more strongly connected to each other. This helps the fitted embankment blocks secured by the internal wire to withstand the additional pressure that may be applied to the embankment due to the seasonal and environmental changes affecting the embankement.

Accordingly, the embankment blocks according to the various embodiments of the present invention are utilized to create an embankment that not only provides the much improved, yet necessary structural support but also acts as a relatively cost effective advertising medium.

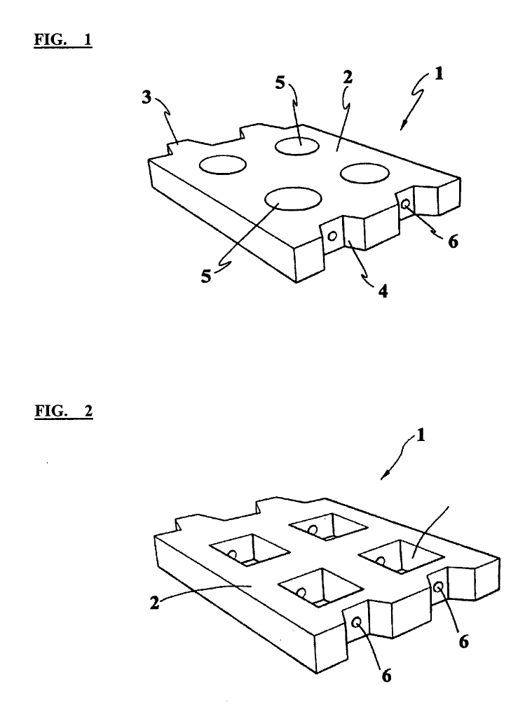

FIG. 1 shows an embankment block 1 according to a first embodiment of the present invention. The main body 2 of the embankment block 1 has generally flat top and bottom surfaces and four sides (however, it should be readily recognized that irregular surfaces and the different number of sides other than four are also within the scope and spirit of the present invention). On one side is formed one or more receiving parts 4, and on another side (usually the side opposite to the side having the receiving part 4) is formed one or more protruding parts 3.

The shape of the protruding parts 3 and the shape of the receiving parts 4 are complimentary to each other. Thus, although various shapes are possible, the shape of the protruding and receiving parts 3, 4 as shown in FIG. 1 is trapezoidal so that the protruding part 3 of one embankment block would be fitted into the receiving part 4 of another embankment block for assembly.

Internal to the main body 2, one or more wire paths 6 are formed. Each of the wire paths 6 runs internally from one side of the main body 2 to another side of the main body 2. As shown in FIG. 1, one opening of the wire path 6 is formed in the receiving part 4. The other opening (not shown in FIG. 1) is then formed in the protruding part 3 such that the two openings would meet when two embankments blocks are fitted together. Therefore, when the numerous embankment blocks are fitted and assembled together, one continuous wire path 6 would run internally through a series of contiguous embankment blocks. A wire 7 (FIGS. 7 and 9-10) of galvanized steel (or strings or others) can then be run through the wire path 6 securing the fitting between the contiguous and/or adjacent embankment blocks 1.

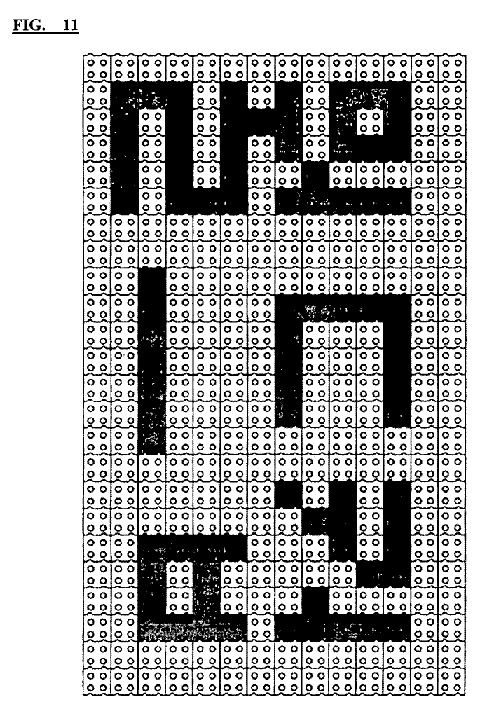

This is well shown in FIG. 10, in which an embankment is formed by an array of fitted embankment blocks 1, and a series of contiguous blocks are held together by the wires 7 running internally through the wire paths (labeled as 6 in FIG. 1, but not labeled in FIG. 10). In this manner, the wire 7 securely and strongly connects and holds the blocks tightly together so as to prevent any of the embankment blocks 1 from being separated and lost in a heavy storm or by a fast-running stream of water.

Now referring back to FIG. 1, the main body 2 has one or more vegetation openings 5 that are essentially holes formed between the top and bottom surfaces of the main body 2. As shown in FIG. 1, the vegetation openings 5 are circular in shape. However, it should be readily recognized that different shapes other than the round shape are also within the scope and spirit of the present invention. For example, the vegetation openings 5 as shown in FIG. 10 are of rectangular or square shape. As seen in FIG. 10, vegetation (A) can be grown through a selected number of the vegetation openings 5. (It is noted that equivalent parts in an embankment block of the present invention are referenced by a same reference numeral in different figures of the drawings although the parts may differ in shapes, for example, the vegetation openings 5 in FIGS. 1 and 10.)

FIG. 2 shows an embankment block 1 according to a second embodiment of the present invention where the embankment block 1 of FIG. 2 is substantially similar to the embankment block 1 of FIG. 1, with the difference between these two embankment blocks 1 of FIGS. 1-2 that lies in the shape of the vegetation sections 5, and the protruding and receiving parts 3, 4. As shown by FIGS. 1-2, various shapes are possible for the vegetation section 5 (e.g., circular, oval, rectangular, diamond, square, etc.), and similarly various shapes are also possible for the protruding and receiving parts 3, 4 (e.g., trapezoidal, semicircular, triangular, etc.).

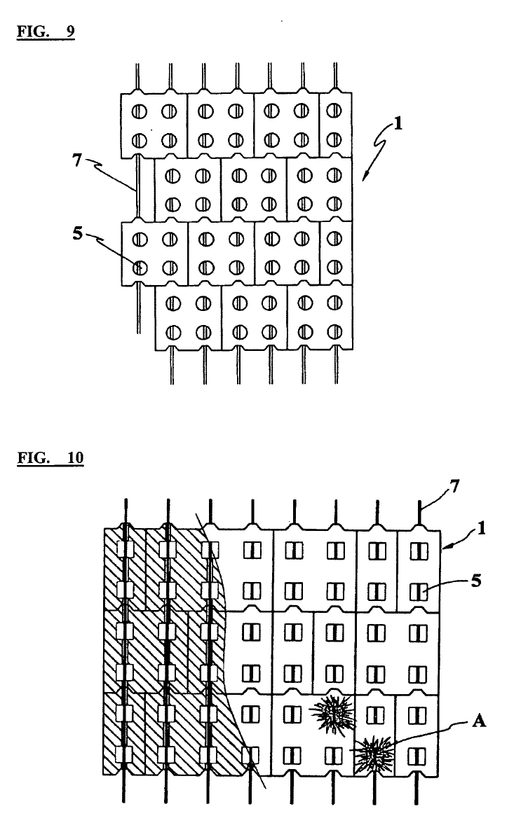

FIG. 9 (similar to FIG. 10) shows an array of embankment blocks 1 that have circularly-shaped protruding and receiving parts (e.g., labeled as 3 and 4, respectively in FIG. 2) on each embankment block 1. An array of fitted embankment blocks 1 are assembled into an embankment, and a series of contiguous blocks are held together by the wires 7 running internally through the wire paths (labeled as 6 in FIG. 2, but not labeled in FIG. 9). In this manner, the wire 7 securely and strongly connects and holds the blocks tightly together so as to prevent any of the embankment blocks 1 from being separated and lost in a heavy storm or by a fast-running stream of water.

Further, as shown in FIGS. 3-4, a different number of vegetation openings 5 can be formed in the embankment block 1. Whereas each of the embankment blocks 1 shown in FIGS. 1-2 has four vegetations openings 5, there are two vegetation openings 5 formed in the embankment block 1 of FIGS. 3-4.

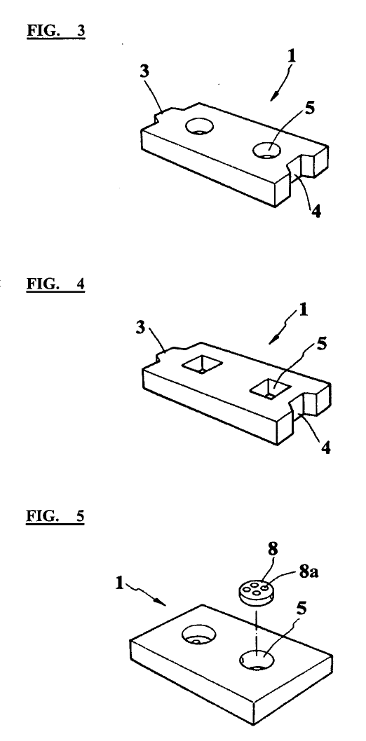

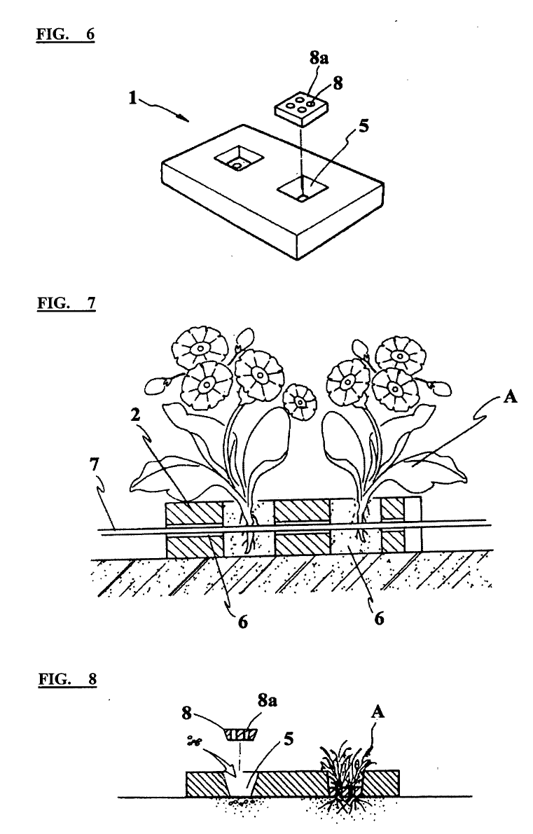

Now referring to FIGS. 5-6, a vegetation block 8 having one or more vegetation holes 8a can be used to cover up the vegetation opening 5. As shown in FIGS. 5-6, the shape of the vegetation block 8 is designed to compliment the shape of the vegetation opening 5. In FIG. 5, the vegetation block 8 is round with tapered edge to compliment the round and tapered edges of the vegetation opening 5. Likewise in FIG. 6, the vegetation block 8 is square-shaped with tapered edge to compliment the square-shaped and tapered vegetation opening 5. However, it should be recognized that many different shapes of the vegetation block 8 is possible just as numerous shapes of vegetation opening 5 are possible.

Now referring to FIGS. 7-8, the vegetation block 8 is fitted at the bottom portion of the vegetation opening 5. The vegetation (A), which may be a flower in case of FIG. 7 or grass in case of FIG. 8 can then be grown through the vegetation holes 8a. The vegetation (A) grows out of the vegetation hole 8a such that the vegetation hole 8a is effectively closed by the stem and root structure of the vegetation (A). This ensures that during a heavy downpour of precipitating water during a storm, the bulk of water would not flow through the vegetation openings 5, but instead would flow along the downward slope of the top surface of the embankment blocks 1. This also prevents weakening of the soil underneath the embankment blocks 1 by the seeping water, and therefore the structural integrity of the embankment blocks covering up the soil is better preserved.

Alternatively, a cap block 9 (FIG. 8) can be used to cover up the vegetation opening 5. Unlike the vegetation opening 8 which has vegetation holes 8a, the cap block 9 does not have any holes. Therefore, the cap block 9 is used to cover up the vegetation opening 5, in case the growth of vegetation is not desired.

As shown in FIGS. 7-9, the height of the embankment block 1 is greater than the height of either the vegetation block 8 or the cap block 9. This is to preserve the continuity of the wire path 6 through the vegetation holes 5, such that no vegetation blocks 8 or cap blocks 9 fitted inside the vegetation holes 5 would obstruct the wire 7 from going through. According to one embodiment of the present invention, the height of the embankment block 1 is set to 100 mm and the height of the vegetation block or the cap block is set to 30 mm. Nevertheless, it should be readily recognized that other heights (whether same or different) of these blocks are possible and are within the spirit and scope of the present invention so long as the continuity of the wire path 6 is preserved through the vegetation holes 5 and between a series of contiguous embankment blocks 1.

FIG. 11 shows an embankment (assembled by a plurality of the embankment blocks 1 of the present invention) that can serve as a medium for advertisement and/or dissemination of message. As shown in FIG. 11, one distinguishing type of vegetation can be grown through a specifically selected number of embankment blocks to form a pattern of message. The pattern shown in FIG. 11 represents three Korean characters “ [symbol] ” that phonetically translates to “World Cup” in English. Accordingly, as shown in FIG. 11, the intended images or messages can be expressed on the surface of an embankment of the present invention by planting specific distinguishing types of plants or vegetation according to the pattern of the characters, images, etc. Outside the pattern, different distinguishing vegetation or plants (or no vegetation or plants) can be grown to allow the pattern of message to stand out of the embankment. This allows local municipalities or businesses or interested others to take advantage of the embankment as described herein as an advertisement medium, which may be a very cost effective alternative to other known advertising methods.

It will be clear that the present invention is well adapted to attain the ends and advantages mentioned as well as those inherent therein. While a various embodiments including the presently preferred one has been described for purposes of this disclosure, various changes and modifications may be made, which are well within the scope of the present invention. Numerous other changes may be made which will readily suggest themselves to those skilled in the art and which are encompassed in the spirit of the invention disclosed and as defined in the appended claims.

1-4. (canceled)

5. An embankment block having a main body defined by a top surface, a bottom surface, and at least a first side and a second side, the embankment block comprising:
a vegetation opening formed between the top and bottom surfaces of the main body, wherein the vegetation opening allows a vegetation to grow through the vegetation opening;
a protruding part formed on the first side of the main body;
a receiving part formed on the second side of the main body, wherein the shape of the protruding part is substantially complimentary to the shape of the receiving part; and
a wire path formed inside the main body, wherein the wire path has two wire path openings and each of the wire path openings is formed on a selected side of the main body.

6. The embankment block of claim 5, further comprising a cap block that fits inside the vegetation opening of the main body, wherein the cap block is shaped to substantially compliment the shape of the vegetation opening of the main body.

7. The embankment block of claim 6, wherein the edges of the cap block and the edges of the vegetation opening are tapered at an angle.

8. The embankment block of claim 6, wherein the height of the cap block and the height of the main body are different.

9. The embankment block of claim 8, wherein the height of the cap block is about 30 mm and the height of the main body is about 100 mm.

10. The embankment block of claim 5, further comprising a vegetation block that fits inside the vegetation opening of the main body, wherein the vegetation block is shaped to substantially compliment the shape of the vegetation opening of the main body, and further wherein the vegetation block has one or more vegetation holes through which a plant can grow when the main body is laid over soil, such that the plant substantially closes the vegetation holes and thereby prevents water from directly flowing into the soil through the vegetation opening and such that the plant provides a visual effect to a viewer.

11. The embankment block of claim 10, wherein the edges of the vegetation block and the edges of the vegetation opening are tapered at an angle.

12. The embankment block of claim 10, wherein the height of the vegetation block and the height of the main body are different.

13. The embankment block of claim 12, wherein the height of the vegetation block is about 30 mm and the height of the main body is about 100 mm.

14. The embankment block of claim 5, wherein one opening of the wire path is located on the protruding part of the main body and the other opening of the wire path is located on the receiving part of the main body.

15. The embankment block of claim 14, wherein the wire path accommodates a wire to run through from one wire path opening to the other wire path opening.

16. An advertising embankment constructed by a plurality of embankment blocks fitted together to form a substantially two-dimensional surface,
wherein each of the embankment blocks having a main body defined by a top surface, a bottom surface, and at least a first side and a second side comprises:
a vegetation opening formed between the top and bottom surfaces of the main body, wherein the vegetation opening allows a vegetation to grow through the vegetation opening;
a protruding part formed on the first side of the main body;
a receiving part formed on the second side of the main body, wherein the shape of the protruding part is substantially complimentary to the shape of the receiving part; and
a wire path formed inside the main body and running between two wire path openings such that one wire path opening is formed on the protruding part and another wire path opening is formed on the receiving part;
wherein each of the embankment blocks are contiguously fitted together by one protruding part of one embankment block fitted into the receiving part of an adjacent embankment block; and
wherein plants are grown through a predetermined number of the vegetation openings of the embankment blocks such that the grown plants when viewed form a pattern.

17. The advertising embankment of claim 16, wherein the wire path opening of the protruding part of one embankment block coincides with the wire path opening of the receiving part of another embankment block such that when the two embankment blocks are fitted together a continuous wire path is created internally through the two embankment blocks.

18. The advertising embankment of claim 17, wherein a wire runs through the continuous wire path to provide a strong connection between the two embankment blocks fitted together.

19. The advertising embankment of claim 16, further comprising a vegetation block that fits inside the vegetation opening of the main body, wherein the vegetation block is shaped to substantially compliment the shape of the vegetation opening of the main body, and further wherein the vegetation block has one or more vegetation holes through which a plant can grow when the main body is laid over soil, such that the plant substantially closes the vegetation holes and thereby prevents water from directly flowing into the soil through the vegetation opening and such that the plant provides a visual effect to a viewer.
